(19) United States
(12) Patent Application Publication
(10) Pub. No.: US 2013/0009918 A1
(43) Pub. Date: Jan. 10, 2013

(54) SOURCE DRIVER

(75) Inventor: Shun-Hsun Yang, Hsinchu (TW)

(73) Assignee: NOVATEK MICROELECTRONICS CORP., Hsinchu (TW)

(21) Appl. No.: 13/281,390

(22) Filed: Oct. 25, 2011

(30) Foreign Application Priority Data
Jul. 8, 2011 (TW) 100124272

(51) Int. Cl. G09G 5/00

(52) U.S. Cl. 345/204

(57) ABSTRACT

The invention provides a source driver, which includes a plurality of channel driving circuits, a polarity-controlling circuit and a boundary judgment unit. In order to avoid abnormal frames caused by the polarity-controlling circuit and special input data, for example, the input data of the FRC algorithm, the source driver employs the boundary judgment unit to prevent the abnormal frames.

### CROSS-REFERENCE TO RELATED APPLICATION

This application claims the priority benefit of Taiwan application serial no. 100124272, filed on Jul. 8, 2011. The entirety of the above-mentioned patent application is hereby incorporated by reference herein and made a part of this specification.

### BACKGROUND OF THE INVENTION

1. Field of the Invention

The invention generally relates to a display device, and more particularly, to a source driver able to dynamically switch between a plurality of liquid crystal (LC) polarity inversion modes.

2. Description of Related Art

Due to the characteristic of LC itself, during driving LCs, the LC polarity needs to be frequently inversed. Against different energy-consuming demands, many different LC polarity inversion modes have been developed, for example, column inversion mode and dot inversion mode. The major power consumption of a source driver is operation power consumption for frequently inversing polarity. Accordingly, the dot inversion mode is the most power-consuming, while the column inversion mode is the one saving more power relatively to other polarity inversion modes. However, the inversing time of the column inversion mode is too long so as to easily affect LC display quality.

### SUMMARY OF THE INVENTION

Accordingly, the invention is directed to a source driver, which is able to reduce abnormal frame under frame rate control algorithm (FRC algorithm).

The embodiments of the invention provide a source driver, which includes a plurality of channel groups and a boundary judgment unit, in which each of the channel groups has a plurality of channel driving circuits and a polarity-controlling circuit. In any one channel group among the channel groups, the polarity-controlling circuit checks display data of the said channel driving circuits to obtain a first checking result, and the polarity-controlling circuit determines the said channel driving circuits to operate in a first polarity inversion mode or a second polarity inversion mode according to the first checking result. The boundary judgment unit checks a plurality of gray level values of the display data of all the channel driving circuits of the said channel groups to determine whether or not a plurality of certain gray level values are included in the above-mentioned gray level values for obtaining a second checking result, and determine whether or not to disable all the polarity-controlling circuits of the said channel groups according to the second checking result.

In an embodiment, when the boundary judgment unit judges out the gray level values of the display data of any one among the said channel groups include the certain gray level values, the boundary judgment unit disables all the polarity-controlling circuits of the said channel groups; otherwise, the boundary judgment unit enables all the polarity-controlling circuits of the said channel groups.

In an embodiment, the above-mentioned first polarity inversion mode and second polarity inversion mode are respectively dot inversion mode and column inversion mode.

In an embodiment, in any one channel group among the channel groups, when the polarity-controlling circuit is enabled, the polarity-controlling circuit checks display data of the said channel driving circuits, and determines the said channel driving circuits to operate in the first polarity inversion mode or the second polarity inversion mode according to the first checking result. In any one channel group among the channel groups, when the polarity-controlling circuit is disabled, the polarity-controlling circuit makes all the channel driving circuits operate in the first polarity inversion mode.

In an embodiment, in any one channel group among the channel groups, the polarity-controlling circuit includes a multiplexer and a data processing unit. An output terminal of the multiplexer controls the said channel driving circuits in the channel group to operate in the first polarity inversion mode or the second polarity inversion mode. An first input terminal and a second input terminal of the multiplexer respectively receive a first polarity control signal and a second polarity control signal, wherein the first polarity control signal and the second polarity control signal are respectively corresponding to the first polarity inversion mode and the second polarity inversion mode. The data processing unit has an enabling terminal coupled to the boundary judgment unit and an output terminal coupled to the control terminal of the multiplexer, and the data processing unit checks display data of the channel driving circuits in the channel group and controls the multiplexer to output the first polarity control signal or the second polarity control signal according to a checking result.

In an embodiment, a first pair among the above-mentioned certain gray level values is located at a first turning place of a characteristic curve of liquid crystal transmittance vs. voltage. In another embodiment, a second pair among the certain gray level values is located at a second turning place of the characteristic curve of liquid crystal transmittance vs. voltage.

In an embodiment, the above-mentioned first pair of the certain gray level values is two adjacent gray level values at the first turning place. In another embodiment, the above-mentioned second pair of the certain gray level values is two adjacent gray level values at the second turning place.

The embodiments of the invention employ an additional boundary judgment unit in the source driver. If the boundary judgment unit judges out the gray level values of the display data of any one among the channel groups include the adjacent gray level values of any one turning point, the boundary judgment unit disables all the polarity-controlling circuits of the said channel groups; otherwise, the boundary judgment unit enables all the polarity-controlling circuits of the said channel groups. When the polarity-controlling circuit is enabled, the polarity-controlling circuit checks display data of the said channel driving circuits and determines the said channel driving circuits to dynamically operate in a first polarity inversion mode or a second polarity inversion mode according to a checking result. When the polarity-controlling circuit is disabled, the polarity-controlling circuit makes the channel driving circuits statically operate in a first polarity inversion mode. By using the method, the abnormal frame problem of the source driver under the FRC algorithm can be reduced.

Other objectives, features and advantages of the present invention will be further understood from the further technological features disclosed by the embodiments of the present invention wherein there are shown and described preferred embodiments of this invention, simply by way of illustration of modes best suited to carry out the invention.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a schematic diagram of function blocks in an embodiment of channel groups in a source driver.

FIG. 2 is a characteristic curve of liquid crystal transmittance vs. voltage.

FIG. 3 is a schematic diagram of function blocks in a source driver 300 according to an embodiment.

### DESCRIPTION OF THE EMBODIMENTS

For a source driver, the power consumption mainly rests in frequently inversing polarities, in which the dot inversion mode is most power-consuming, while the column inversion mode is the most power-saving one compared to other polarity inversion modes. Taking a balanced consideration between cost and display quality, the embodiment enables a plurality of channel groups of the source driver to respectively dynamically operate in the dot inversion mode and the column inversion mode according to a characteristic curve of liquid crystal transmittance vs. voltage. By dynamically switching between different polarity inversion modes, the source driver can select an appropriate gray level to perform the column inversion so as to achieve a balance point between power-saving and without affecting frame display.

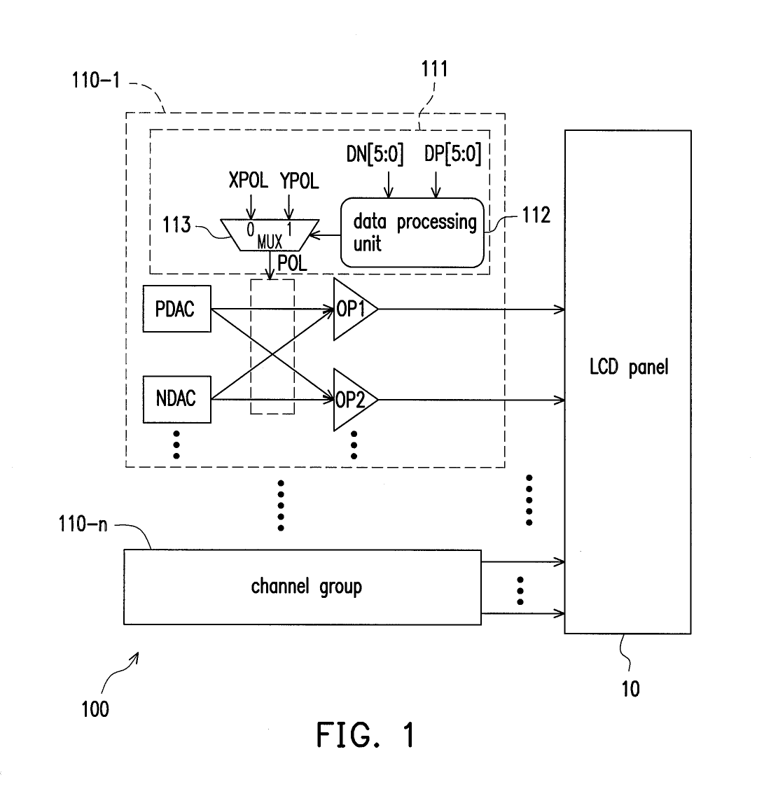

FIG. 1 is a schematic diagram of function blocks in an embodiment of channel groups in a source driver 100. Referring to FIG. 1, the source driver 100 has n channel groups, for example, a channel group 110-1 and a channel group 110-n (n is a positive integer). Each of the channel groups has a polarity-controlling circuit and a plurality of channel driving circuits. For example, the channel group 110-1 has a polarity-controlling circuit 111 and a plurality of channel driving circuits (for example, the two channel driving circuits in FIG. 1). The implementation of the channel group 110-1 is explained as follows, while the implementation for the other channel groups (for example, the channel group 110-n) can refer to the depiction of the channel group 110-1.

All the channel driving circuits of the channel groups from 110-1 to 110-n can use digital-to-analog converters (DACs) to convert the digital display data into analog gray level voltages with specific polarities, followed by transmitting the gray level voltages to an LCD panel 10 by an operation amplifier. The output polarities of the channel groups from 110-1 to 110-n are determined by polarity control signals output from the polarity-controlling circuits.

For example, a DAC PDAC of the channel driving circuits can convert display data DP[5:0] into positive-polarity gray level voltages, while display data DN[5:0] of the channel driving circuits can be converted into negative-polarity gray level voltages by a DAC NDAC. When a polarity control signal POL output from a polarity-controlling circuit 111 is at a first logic level (for example, a high-level), the DAC PDAC can transmit the positive-polarity gray level voltage to an operation amplifier OP1 and the DAC NDAC can transmit the negative-polarity gray level voltage to an operation amplifier OP2. In this way, a first data line of the LCD panel 10 can receive the positive-polarity gray level voltage output from the operation amplifier OP1 of a channel driving circuit, and a second data line of the LCD panel 10 can receive the negative-polarity gray level voltage output from the operation amplifier OP2 of another channel driving circuit. On the contrary, when the polarity control signal POL is at a second logic level (for example, a low-level), the DAC PDAC can transmit the positive-polarity gray level voltage to an operation amplifier OP2 and the DAC NDAC can transmit the negative-polarity gray level voltage to the operation amplifier OP1. In this way, the first data line of the LCD panel 10 can receive the negative-polarity gray level voltage output from the operation amplifier OP1, and the second data line of the LCD panel 10 can receive the positive-polarity gray level voltage output from the operation amplifier OP2.

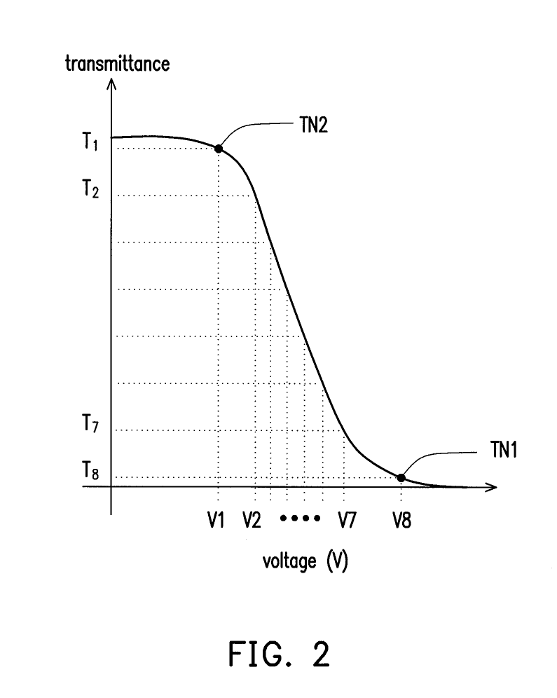

FIG. 2 is a characteristic curve of liquid crystal transmittance vs. voltage, in which the abscissa is gray level voltage values applied on the liquid crystals (for example, gray level voltages V1, V2, V7 and V8) and the ordinate is liquid crystal transmittance (for example, transmittances T1, T2, T7 and T8). It can be seen from the curve that the characteristic curve of liquid crystal transmittance vs. voltage has a first turning place TN1 at a location roughly nearby a gray level voltage V8 and has a second turning place TN2 at a location roughly nearby a gray level voltage V1. At both ends of the curve (below the gray level voltage V1 or beyond the gray level voltage V8), the variation of the curve is relatively slight, which means the variation of the gray level voltage has less significant impact on the variation of the liquid crystal transmittance. However, corresponding to a voltage interval between the gray level voltage V1 and the gray level voltage V8, the curve is relatively steep, which means little change of the gray level voltage can bring dramatic impact on the variation of the liquid crystal transmittance.

As a result, when the gray level voltages of the LCD panel 10 are operating a voltage interval below the gray level voltage V1 or beyond the gray level voltage V8, no matter which polarity inversion mode a channel group (for example, the channel group 110-1) adopts, it is unlikely for the user to feel the flicker problem on the LCD panel 10. Based on the reason, for the gray level voltage interval with the relatively slight variation, the polarity-controlling circuit 111 can control all the channel driving circuits of the channel group 110-1 to operate in the column inversion mode so as to reduce the alternating current (AC) power consumption of the source driver.

On the contrary, when the gray level voltages of the LCD panel 10 are operating in a voltage interval from the gray level voltage V1 to the gray level voltage V8, the polarity-controlling circuit 111 can control all the channel driving circuits of the channel group 110-1 to operate in the dot inversion mode so as to reduce the flicker problem and hence increase the display performance of the LCD panel 10.

That is to say, the polarity-controlling circuit 111 can check the display data of all the channel driving circuits of the channel group 110-1 and dynamically determine the channel driving circuits to operate in dot inversion mode or column inversion mode according to the checking result. Hence, the channel group 110-1 can work at a balance point to save power without affecting the frame display.

Referring to FIG. 1 again, in any channel group among the channel groups, for example, in the channel group 110-1, the above-mentioned polarity-controlling circuit 111 includes a data processing unit 112 and a multiplexer 113. The data processing unit 112 has an output terminal coupled to a control terminal of the multiplexer 113. The output terminal of the multiplexer 113 controls all the channel driving circuits in the channel group 110-1 to operate in the first polarity inversion mode (for example, the dot inversion mode) or the second polarity inversion mode (for example, the column inversion mode) through a polarity control signal POL. A first input terminal and a second input terminal of the multiplexer 113 respectively receive a first polarity control signal XPOL and a second polarity control signal YPOL, in which the first polarity control signal XPOL and the second polarity control signal YPOL are respectively corresponding to the first polarity inversion mode and the second polarity inversion mode. The data processing unit 112 checks display data (for example, two display data DP[5:0] and DN[5:0]) of the channel driving circuits in the channel group 110-1 and judges which polarity inversion mode is to be switched to presently according to a checking result. After the judgment, the data processing unit 112 sends a selection signal to the multiplexer 113, and at the same time, the multiplexer 113 would output the first polarity control signal XPOL indicating the “dot inversion mode” or the second polarity control signal YPOL indicating the “column inversion mode” to all the channel driving circuits in the channel group 110-1 according to the selection signal of the data processing unit 112. In this way, the data processing unit 112 is able to check the display data of all the channel driving circuits of the channel group 110-1 and dynamically control the channel driving circuits to operate in the dot inversion mode or the column inversion mode according to the checking result.

On the other hand, with greater bit number of the display data, more gray levels the display data can be implemented, but higher hardware costs are caused. In the liquid crystal gray level processing method, in order to take a balanced consideration between cost and display quality, the source driver 100 can use an FRC algorithm to produce more gray levels with fewer bits of the display data. For example, the bit number of the display data is 6-bits, and the 6-bits display data can define 64 gray levels. By using the human visual persistence characteristic and accumulation effect in space (or time), the FRC algorithm can make the original 6-bits gray level performance simulate the 8-bits gray level performance. The FRC algorithm is a well-known algorithm, which is omitted to detail.

The FRC algorithm may make two adjacent pixels in space (or time) respectively have a gray level m and a gray level m+1, so as to accumulate a gray-level performance between the gray level m and the gray level m+1 by using the human visual persistence characteristic in space (or time). However, when the source driver 100 is running the FRC algorithm, if the polarity-controlling circuit 111 simultaneously performs the above-mentioned dynamical switching of polarity inversion modes, discontinuous images may occur at a location in a display frame corresponding to the intersection between two adjacent channel groups.

For example, it is assumed that the two adjacent channel groups are respectively a first channel group and a second channel group, the channel adjacent to the second channel group in the first channel group is CH1, the channel adjacent to the first channel group in the second channel group is CH2, and the first turning place TN1 in FIG. 2 falls between the gray level m and the gray level m+1. When the channel CH1 outputs the gray level m, due to the source driver 100 running the FRC algorithm, it is possible the channel CH2 adjacent to the channel CH1 outputs the gray level m+1. Hence, the first channel group may run in the dot inversion mode, while the second channel group may run in the column inversion mode. At the intersection between two adjacent channel groups, the FRC algorithm makes the first channel group and the second channel group respectively running in two different polarity inversion modes and therefore produces discontinuous images. Although increasing the channel number in a channel group can reduce the probability of the discontinuous images, it is unable to achieve higher power-saving efficiency.

In order to improve the above-mentioned discontinuous displaying and achieve higher power-saving efficiency, a following embodiment employs an additional boundary judgment mechanism on a polarity-controlling unit. The boundary judgment mechanism is advantageous in reducing the probability of producing the discontinuous images and effectively improving the discontinuous gray level displaying of the boundary, without the need to increase the channel number in a channel group. Such a polarity-controlling unit using the boundary judgment mechanism can be referred to as a hierarchical polarity control unit.

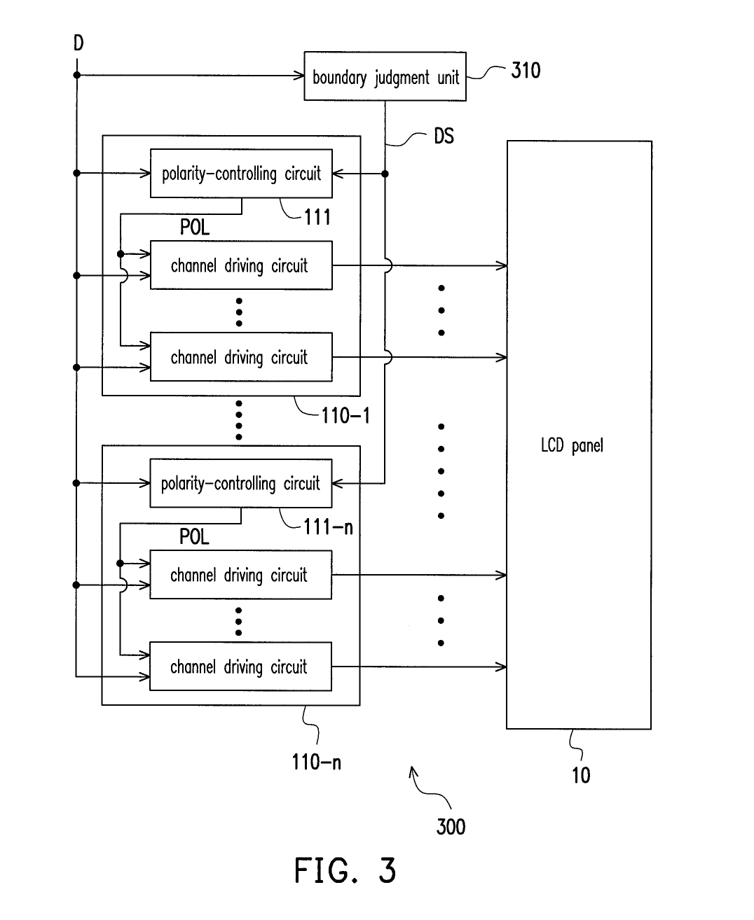

For example, FIG. 3 is a schematic diagram of function blocks in a source driver 300 according to an embodiment. The source driver 300 includes a first channel group (for example, the channel group 110-1) and a second channel group (for example, the channel group 110-n) and a boundary judgment unit 310. The source driver 300 is not limited to having two channel groups 110-1 and 110-n only, and the number thereof can be changed according to the design requirement. The display data D is transmitted to all the channel driving circuits of the channel groups (for example, 110-1 and 110-n). The channel driving circuits of the channel groups from 110-1 to 110-n would convert the digital display data D into analog gray level voltages with a specific polarity through the DAC according to the polarity control signal POL, followed by transmitting the gray level voltages to the LCD panel 10 through the operation amplifier. The detail of the source driver 300 in FIG. 3 can refer to the depiction of FIGS. 1 and 2 except that the source driver 300 of FIG. 3 further employs a boundary judgment unit 310.

Referring to FIG. 3, the boundary judgment unit 310 checks a plurality of gray level values of the display data of all the channel driving circuits of the channel groups (for example, 110-1 and 110-n) so as to judge whether or not the above-mentioned data contain a plurality of certain gray level values, and then, determines whether or not to disable all the channel driving circuits of the above-mentioned channel groups according to the checking result. Preferably, the above-mentioned certain gray level values include the two adjacent gray level values at the first turning place TN1 (for example, 111011 and 111100) or the two adjacent gray level values at the second turning place TN2 (for example, 000011 and 000100) on the characteristic curve of liquid crystal transmittance vs. voltage of FIG. 2. More preferably, the above-mentioned certain gray level values include both the two adjacent gray level values at the first turning place TN1 and the two adjacent gray level values at the second turning place TN2.

In the description as follows, it is assumed that the display data D are 6-bits gray level values, and the first turning place TN1 of the characteristic curve of liquid crystal transmittance vs. voltage is defined at the two adjacent gray level values of 111100 and 111011, and the second turning place TN2 is defined at the two adjacent gray level values of 000011 and 000100. However, the above-mentioned bit number and the certain gray level values of 000011, 000100, 111100 and 111011 serve as an example only, and the real bit number and the certain gray level values can be determined according to the design requirement and the material of the LCD panel 10.

In an exemplary case, it is assumed the certain gray level values are the two adjacent gray level values 111011 and 111100 at the first turning place TN1 of the characteristic curve of liquid crystal transmittance vs. voltage (FIG. 2). If the boundary judgment unit 310 finds out at least one gray level value among the n gray level values of the n pieces of display data of all the channel driving circuits of the channel groups from 110-1 to 110-n is the certain gray level value 111100 and at least one gray level value is the certain gray level value 111101, the boundary judgment unit 310 would output a control signal DS to disable all the polarity-controlling circuits of the channel groups from 110-1 to 110-n (for example, the polarity-controlling circuits 111 and 111-n).

After the polarity-controlling circuits 111 are disabled, the polarity-controlling circuits 111 would not perform the above-mentioned dynamically switching operation of polarity inversion modes. Instead, the polarity-controlling circuits 111 outputs the polarity control signal POL to all the channel driving circuits of the channel group 110-1, so that all the channel driving circuits of the channel group 110-1 continue to operate in the preset first polarity inversion mode (for example, dot inversion mode). The above-mentioned mechanism can be also applied to the polarity-controlling circuit 111-n. That is to say, if the boundary judgment unit 310 finds that the n gray level values of the channel groups from 110-1 to 110-n include the certain gray level values 111011 and 111100, then, all the channel driving circuits of the channel groups from 110-1 to 110-n can operate in dot inversion mode.

On the contrary, if the boundary judgment unit 310 finds that the n gray level values of the n pieces of display data of the channel groups from 110-1 to 110-n do not include both the gray level values 111011 and 111100, the boundary judgment unit 310 would output the control signal DS to enable all the polarity-controlling circuits of the channel groups from 110-1 to 110-n (for example, the polarity-controlling circuits 111 and 111-n). After the polarity-controlling circuits 111 (the same also for 111-n) are enabled, the polarity-controlling circuits 111 would perform the above-mentioned dynamically switching operation of polarity inversion modes (referring to the depiction of FIGS. 1 and 2). That is to say, when the polarity-controlling circuits 111 are enabled, the polarity-controlling circuits 111 check the display data of all the channel driving circuits of the channel group 110-1 so as to determine all the channel driving circuits of the channel group 110-1 to operate in the first polarity inversion mode (for example, dot inversion mode) or the second polarity inversion mode (for example, column inversion mode) according to the checking result.

In another exemplary case, it is assumed the certain gray level values are the two adjacent gray level values 111011 and 111100 at the first turning place TN1 of the characteristic curve of liquid crystal transmittance vs. voltage (FIG. 2) and the two adjacent gray level values 000011 and 000100 at the second turning place TN2.

If both the certain gray level values 000011 and 000100 are contained in all the channel driving circuits of the channel groups from 110-1 to 110-n, or both the certain gray level values 111100 and 111011 are contained in all the channel driving circuits of the channel groups from 110-1 to 110-n, the boundary judgment unit 310 would output the control signal DS to disable all the polarity-controlling circuits of the channel groups from 110-1 to 110-n (for example, the polarity-controlling circuits 111 and 111-n). After the polarity-controlling circuits 111 (the same also for 111-n) are disabled, the polarity-controlling circuits 111 would make all the channel driving circuits of the channel group 110-1 continue to operate in the preset dot inversion mode through the polarity control signal POL. At the same time, the polarity-controlling circuit 111 does not change the polarity inversion mode of all the channel driving circuits of the channel group 110-1. In other words, when any two gray level values in the n pieces of display data of the channel groups from 110-1 to 110-n fall at the first turning place TN1 or the second turning place TN2 of the characteristic curve of liquid crystal transmittance vs. voltage, the channel groups from 110-1 to 110-n can be forced to operate in dot inversion mode so as to reduce image discontinuousness.

On the contrary, when no gray level value in the display data of the channel groups from 110-1 to 110-n falls at the first turning place TN1 or the second turning place TN2 of the characteristic curve of liquid crystal transmittance vs. voltage, the boundary judgment unit 310 would output the control signal DS to enable all the polarity-controlling circuits of the channel groups from 110-1 to 110-n, in which the polarity-controlling circuit of each of the channel groups from 110-1 to 110-n (for example, the polarity-controlling circuits 111 and 111-n) decides the polarity inversion mode thereof by itself. In this way, the channel groups from 110-1 to 110-n can independently dynamically switch the polarity inversion mode to achieve higher power-saving efficiency.

It should be noted that in the above-mentioned embodiment, the boundary judgment unit 310 checks whether or not any gray level value in the display data of the channel groups from 110-1 to 110-n falls at the first turning place TN1 or the second turning place TN2 of the characteristic curve of liquid crystal transmittance vs. voltage (FIG. 2). In other embodiments however, the boundary judgment unit 310 can only check whether or not any gray level value in the display data of the channel groups from 110-1 to 110-n falls at the first turning place TN1 of the characteristic curve of liquid crystal transmittance vs. voltage without checking for the second turning place TN2, because the gray level voltage V1 at the second turning place TN2 of FIG. 2 is often small. Assuming the power consumption for the source driver 100 operating in dot inversion mode in a voltage interval below the gray level voltage V1 can meet design requirement, the boundary judgment unit 310 has no need to check whether or not any gray level value falls at the second turning place TN2.

In summary, the boundary judgment unit 310 in the embodiments can judge out whether to enable or disable the polarity-controlling circuit according to the display data of the driving circuits, so that when the display data of the driving circuits appears at the first turning place TN1 or the second turning place TN2, the polarity-controlling circuit temporally performs the dynamical switching of the polarity inversion mode, which reduces the probability of abnormal frames. while achieving high display quality and low power consumption.

It will be apparent to those skilled in the art that the descriptions above are several preferred embodiments of the invention only, which does not limit the implementing range of the invention. Various modifications and variations can be made to the structure of the invention without departing from the scope or spirit of the invention. The claim scope of the invention is defined by the claims hereinafter.

What is claimed is:

1. A source driver, comprising:
a plurality of channel groups, wherein each of the channel groups has a plurality of channel driving circuits and a polarity-controlling circuit, and in any one channel group among the channel groups, the polarity-controlling circuit checks display data of the said channel driving circuits to obtain a first checking result, and the polarity-controlling circuit determines the said channel driving circuits to operate in a first polarity inversion mode or a second polarity inversion mode according to the first checking result; and
a boundary judgment unit, checking whether or not a plurality of gray level values of the display data of all the channel driving circuits of the said channel groups comprise a plurality of certain gray level values for obtaining a second checking result, and determine whether or not to disable all the polarity-controlling circuits of the said channel groups according to the second checking result.

2. The source driver as claimed in claim 1, wherein when the boundary judgment unit judges out the gray level values of the display data of any one among the said channel groups comprise the certain gray level values, the boundary judgment unit disables all the polarity-controlling circuits of the said channel groups; otherwise, the boundary judgment unit enables all the polarity-controlling circuits of the said channel groups.

3. The source driver as claimed in claim 1, wherein the first polarity inversion mode and the second polarity inversion mode are respectively dot inversion mode and column inversion mode.

4. The source driver as claimed in claim 1, wherein in any one channel group among the channel groups, when the polarity-controlling circuit is enabled, the polarity-controlling circuit checks display data of the said channel driving circuits and determines the said channel driving circuits to operate in the first polarity inversion mode or the second polarity inversion mode according to the first checking result.

5. The source driver as claimed in claim 1, wherein in any one channel group among the channel groups, when the polarity-controlling circuit is disabled, the polarity-controlling circuit makes all the said channel driving circuits operate in the first polarity inversion mode.

6. The source driver as claimed in claim 1, wherein in any one channel group among the channel groups, the polarity-controlling circuit comprises:
a multiplexer, having an output terminal for controlling the said channel driving circuits in the channel group to operate in the first polarity inversion mode or the second polarity inversion mode, and an first input terminal and a second input terminal for respectively receiving a first polarity control signal and a second polarity control signal respectively corresponding to the first polarity inversion mode and the second polarity inversion mode; and
a data processing unit, having an enabling terminal coupled to the boundary judgment unit and an output terminal coupled to the control terminal of the multiplexer,
wherein the data processing unit checks display data of the channel driving circuits in the channel group and controls the multiplexer to output the first polarity control signal or the second polarity control signal according to a checking result.

7. The source driver as claimed in claim 1, wherein a first pair among the certain gray level values is located at a first turning place of a characteristic curve of liquid crystal transmittance vs. voltage.

8. The source driver as claimed in claim 7, wherein a second pair among the certain gray level values is located at a second turning place of the characteristic curve of liquid crystal transmittance vs. voltage.

9. The source driver as claimed in claim 7, wherein the first pair of the certain gray level values is two adjacent gray level values at the first turning place.

10. The source driver as claimed in claim 8, wherein the second pair of the certain gray level values is two adjacent gray level values at the second turning place.
